(19) United States
(12) Patent Application Publication
(10) Pub. No.: US 2025/0355419 A1
(43) Pub. Date: Nov. 20, 2025

(54) SYSTEM AND METHOD FOR ROBOT PLANNING USING LARGE LANGUAGE MODELS

(71) Applicant: Mitsubishi Electric Research Laboratories, Inc., Cambridge, MA (US)

(72) Inventors: Chiori Hori, Lexington, MA (US); Motonari Kambara, Tokyo (JP); Devesh Jha, Cambridge, MA (US); Diego Romeres, Boston, MA (US); Siddarth Jain, Cambridge, MA (US); Radu Ioan Corcodel, Brookline, MA (US); Kei Ota, Kamakura (JP); Jonathan Le Roux, Arlington, MA (US); Sameer Khurana, Brookline, MA (US)

(73) Assignee: Mitsubishi Electric Research Laboratories, Inc., Cambridge, MA (US)

(21) Appl. No.: 18/773,853

(22) Filed: Jul. 16, 2024

Related U.S. Application Data
(60) Provisional application No. 63/647,926, filed on May 15, 2024.

(51) Int. Cl. G05B 19/4155; B25J 9/16; B25J 13/00; G06F 40/58

(52) U.S. Cl. CPC G05B 19/4155; B25J 9/1656; B25J 13/003; G06F 40/58; G05B 2219/50391

(57) ABSTRACT

A robotic controller for controlling a robot according to a sequence of robotic actions. comprises an input interface configured to receive a plurality of multimodal inputs each specifying instructions for performing a task in a different modality including audio, video, and a text modality. The controller also comprises a multimodal large language model, an action sequence decoder, and a controller. The multimodal LLM includes a multimodal LLM encoder and an LLM decoder. The multimodal LLM encoder is trained with machine learning to transform the multimodal instructions into encodings and the LLM decoder is configured to decode the encodings into a sequence of robotic instructions. The action sequence decoder is trained with machine learning to transform the sequence of robotic instructions into a sequence of actions using a library of robotic skills. The controller is configured to control a robot according to the sequence of actions.

### TECHNICAL FIELD

This invention relates generally to robotic manipulation and more particularly to systems and methods for interactive planning of robots using large language models for generating a sequence of actions executable by a robot.

### BACKGROUND

Robots have been put to use in several real-world applications. They are operational in industrial and factory setups where mission critical and repetitive actions are flawlessly executed for objectives such as large-scale manufacturing of goods, and handling of cargo and the like. Recently, there has been active research to implement robots for handling day to day tasks for humans. Understanding human actions could allow robots to perform a large spectrum of complex manipulation tasks and make collaboration with humans easier. For example, a robotic helper that can perform daily household tasks could be very valuable in future smart homes for assisting older or disabled people. However, it is challenging to design robot agents that can perform such household tasks. Acquiring such skills required for everyday tasks is difficult since collection of data for controlling real robots and training models through supervised learning, especially for long horizon tasks, is a dauntingly complex activity. Thus, approaches to mitigate tedious human expert demonstrations are highly desirable.

Recently, the use of some machine learning models in creating robotic agents for performing open vocabulary tasks has gained traction. However, current solutions based on such models fail to provide robotic actions of acceptable quality. Particularly, these solutions fail to address the granularity and hierarchy of robotic actions required to perform day to day tasks. While some solutions are too rigid in terms of applicable inputs, other approaches suffer from the distribution gap between training and test environments. Consequently, the automatic action sequence generation proposed by these conventional approaches is imperfect to meet the standards of robot planning for day-to-day tasks.

### SUMMARY

Example embodiments described herein are directed towards systems and methods for training a model to predict a robot action sequence from human demonstration videos. It is an object of some embodiments to provide the robot action sequence in the order in which a robot arm can execute them. Towards this end, some example embodiments utilize a large language model (LLM) for action sequence generation for robotic manipulators from human demonstration videos. Some example embodiments integrate different perceptual inputs via a multimodal encoder. This encoder processes a diverse array of inputs, including video, speech, and text, facilitating a comprehensive understanding of the task at hand by assimilating both the visual demonstrations and auditory instructions from the environment along with textual input if provided.

Large Language Models (LLM) refer to a class of powerful artificial intelligence models that are capable of understanding and generating human language. These models are typically based on deep learning architectures, such as transformers, and are trained on large datasets to learn the statistical patterns and structures of language. Some embodiments are based on the recognition that LLMs have been used for a wide range of natural language processing tasks, including text generation, translation, summarization, question answering, and more. They are often used as the backbone of various language-related applications and services due to their ability to understand and generate human-like text. Examples of popular LLMs include OpenAI's GPT (Generative Pre-trained Transformer) models and Google's BERT (Bidirectional Encoder Representations from Transformers).

In an LLM, the encoder and decoder are essential components used for various natural language processing tasks. Specifically, the LLM encoder processes the input text and transforms it into a series of hidden representations that capture the contextual information of the input. Some embodiments are also based on the realization that in transformer-based architectures, the LLM encoder typically consists of multiple layers of self-attention and feedforward neural networks. Each layer refines the representation of the input text by attending to different parts of the input sequence. The final hidden representations produced by the encoder are then passed to the LLM decoder for further processing.

The LLM decoder takes the hidden representations generated by the LLM encoder and uses them to generate an output sequence. Similar to the LLM encoder, the LLM decoder can have transformer-based architectures that include multiple layers of self-attention and feedforward neural networks. However, in addition to self-attention, the LLM decoder can also incorporate cross-attention, allowing it to attend to the encoder's output when generating the output sequence. This enables the LLM decoder to generate output tokens based on the previously generated output tokens and the context provided by the encoder.

Together, the encoder and decoder of an LLM enable the model to process and generate natural language text for tasks such as text generation, translation, and summarization. However, some embodiments are based on the recognition that in the context of robotic applications, such a paradigm may fail or at least be suboptimal.

For example, some embodiments realized that there is a need for generating action sequences for controlling a robot to perform a task from instructions and/or demonstrations of the performance of the task. In theory, the LLM can help in that process by transforming generic instructions and/or demonstrations of the performance of the task into a sequence of actions understandable by a robot controller. That is, generally, a robot controller cannot transform instructions and/or demonstrations of a task into a sequence of control actions for performing a task. However, again, at least in theory, it is possible to use the LLM to transform generic instructions and/or demonstrations of a task into a sequence of specific commands that a robot controller can understand and transform into a sequence of robotic control actions. For example, a robotic controller cannot directly use a generic instruction like “fry a potato” but can understand a sequence of commands that lead to the potato being fried, such as “take a potato”, “peel the potato”, “cut the potato”, “take a pan”, “add oil to the pan”, “put the pan on a hot stove”, “put the potato into the pan”, etc.

It is an object of some embodiments to use LLMs to generate specific robotic instructions understandable by a robotic controller from the generic instructions/demonstrations of the task. Some embodiments are based on the understanding that the generic instructions/demonstrations can come in different modalities and processing these modalities separately degrades the quality of the instructions. However, current LLM systems do not understand different modalities or treat them separately making one of the modalities dominant over another one. This paradigm, however, is suboptimal for robotic applications, because the instructions/demonstrations can come in a manner dependent on each other.

To that end, some embodiments disclose a multimodal LLM suitable for generating a sequence of specific robotic instructions from the generic instructions and/or demonstrations of a task. To address the deficiency of the current LLMs, the embodiments replace the LLM encoder with the multimodal LLM encoder configured to accept the input data of different modalities, such as images, videos, audio, and text, and jointly embed the multimodal input into the hidden representations of the same dimensionality as that of the hidden representation of an LLM encoder. Such a replacement allows for training the multimodal LLM encoder for the LLM decoder with frozen parameters trained for the LLM encoder expecting an input of a single modality.

Indeed, some embodiments are based on recognizing that it is possible to train the multimodal LLM encoder such that the LLM decoder decodes the encoder output into the sequence of robotic instructions. Additionally, or alternatively, some embodiments employ a query-transformer (Q-Former) that translates the multimodal encodings into “text-like” representations that can be ingested by a backend LLM thereby conditioning the LLM decoder to produce its output in the form of the robotic instructions. According to some embodiments, the Q-Former is multimodal. Some example embodiments leverage the LLM as a decoder within the action sequence generation framework such that the extensive knowledge and inferential capabilities inherent in LLMs can be used to refine the generated action sequences. Such an integration allows incorporation of advanced LLMs for robotic manipulation.

Furthermore, it is a realization of some embodiments that at some level of operation, an effective human-robot collaboration for shared goals is necessary for seamless integration of robots in human daily lives. To realize such effective human-robot collaborative systems, multimodal scene understanding is essential to provide robots with the capability to interpret their environment and interact with humans based on such understanding. In some scenarios, the semantic representation power for multimodal reasoning may turn out to be limited because the training data might be insufficient to cover all possible patterns by fusing all modalities. Also, when applying a trained model for action sequence generation to the real world, the automatic action sequence generation may still not be perfect because the trained human demonstration scenes may not always match with the testing environments for robots.

Some embodiments are also directed towards bridging the gap between training and test environment performances for such robot planning systems. Particularly, it is an objective of some embodiments to utilize an action evaluator to determine affordable/feasible actions.

In order to achieve the aforementioned objectives and advantages, some example embodiments provide systems, methods, and computer programs for generating robotic action sequences and controlling robots according to the action sequences.

Accordingly, some example embodiments provide a robotic controller for controlling a robot according to a sequence of robotic actions. The controller comprises an input interface configured to receive a plurality of multimodal inputs each specifying instructions for performing a task in a different modality including audio, video, and a text modality. The controller also comprises a multimodal large language model, an action sequence decoder, and a controller. The multimodal LLM includes a multimodal LLM encoder and an LLM decoder. The multimodal LLM encoder is trained with machine learning to transform the multimodal instructions into encodings and the LLM decoder is configured to decode the encodings into a sequence of robotic instructions. The action sequence decoder is trained with machine learning to transform the sequence of robotic instructions into a sequence of actions using a library of robotic skills. The controller is configured to control a robot according to the sequence of actions.

According to another embodiment of this invention, the robotic controller is configured without the action sequence decoder, wherein the LLM decoder is configured to directly decode the encodings of the encoder into a sequence of actions executable by the robot.

According to some embodiments, the robotic controller may also comprise a query-transformer trained with machine learning to translate the encodings of the multimodal LLM encoder into an instruction conditioning the LLM decoder to produce its output structured in a format compatible with the action sequence decoder.

In yet another example embodiment, a computer-implemented method for controlling a robot according to a sequence of robotic actions is provided. The method comprises receiving a plurality of multimodal inputs each specifying instructions for performing a task in a different modality including audio, video, and a text modality. The method further comprises transforming by a multimodal LLM encoder the multimodal instructions into encodings, and decoding by an LLM decoder the encodings into a sequence of robotic instructions. The method further comprises transforming the sequence of robotic instructions into a sequence of actions based on a library of robotic skills and controlling a robot according to the sequence of actions.

In yet some other example embodiments, a non-transitory computer readable medium having stored thereon computer executable instructions for performing a method for controlling a robot according to a sequence of robotic actions is provided. The method comprises receiving a plurality of multimodal inputs each specifying instructions for performing a task in a different modality including audio, video, and a text modality. The method further comprises transforming by a multimodal LLM encoder the multimodal instructions into encodings, and decoding by an LLM decoder the encodings into a sequence of robotic instructions. The method further comprises transforming the sequence of robotic instructions into a sequence of actions based on a library of robotic skills and controlling a robot according to the sequence of actions.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of a robotic controller for controlling a robot according to a sequence of actions predicted using multimodal inputs, according to some example embodiments;

FIG. 1B illustrates a paradigm of robot action planning for a long horizon goal, according to some example embodiments;

FIG. 2 illustrates a method executed by the robotic controller of FIG. 1A for controlling the robot, according to some example embodiments;

FIG. 3 illustrates schematics of an action sequence generation framework of the robotic controller of FIG. 1A, according to some example embodiments;

FIG. 4A illustrates an overview of an action sequence generation framework comprising an Action Generator and an Action Evaluator, according to some example embodiments;

FIG. 4B illustrates the network architecture of the Action Generator of the action sequence generation framework of FIG. 4A, according to some embodiments;

FIG. 4C illustrates the network architecture of the Action Evaluator of the action sequence generation framework of FIG. 4A, according to some embodiments;

FIG. 4D illustrates a block diagram of a robotic controller for controlling a robot according to a sequence of actions predicted using multimodal inputs, based on the action sequence generation framework of FIG. 4A;

FIG. 5 illustrates schematics of data collection for micro action step generation for a single arm robot, according to some embodiments;

FIG. 6 illustrates schematics of a robot for object manipulation, in accordance with some example embodiments;

FIG. 7 illustrates some components of a controller for controlling a robot in accordance with a sequence of robotic actions, according to some embodiments;

FIG. 8A illustrates a schematic diagram of execution of an assembly operation by the robot, according to some embodiments; and

FIG. 8B illustrates a schematic diagram of execution of a cooking operation by the robot, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Robots have now become an essential component of major tasks in many industries. Dedicated as well as reprogrammable robots are put in use to perform mission critical tasks with accuracy and speed. Traditionally, robot control involved explicit programming which limited their adaptability and restricted their functionality to predefined tasks. However, recent advancements in machine learning, computer vision, and artificial intelligence have paved the way for new approaches to robot control, making it possible to control robots using visual information extracted from videos. The applications of robot control and manipulation by robots of their environment are immense, such as in hospitals, elderly and childcare, factories, outer space, restaurants, service industries, and homes. Such a wide variety of deployment scenarios, and the pervasive and unsystematic environmental variations in even quite specialized scenarios like food preparation, suggest that there is a need for rapid training of a robot for effective control.

Understanding human actions could allow robots to perform a large spectrum of complex manipulation tasks and make collaboration with humans easier. Effective human-robot collaboration for shared goals is necessary for seamless integration of robots in human daily lives. To realize such effective human-robot collaborative systems, multimodal scene understanding is essential to provide robots with the capability to interpret their environment and interact with humans based on such understanding.

Example embodiments described herein are directed towards systems and methods for training a model to predict a robot action sequence from human demonstration videos. It is an object of some embodiments to provide the sequence of robot actions in the order in which a robot arm can execute them. Towards this end, one approach is to utilize a large language model (LLM) for action sequence generation for robotic manipulators from human demonstration videos. However, current LLM systems do not understand different modalities or treat them separately making one of the modalities dominant over another one. This paradigm, however, is suboptimal for robotic applications, because the instructions or demonstrations can come in a manner dependent on each other. Some example embodiments integrate different perceptual inputs via a multimodal encoder and thus provide a multimodal LLM suitable for generating a sequence of specific robotic instructions from the generic instructions and/or demonstrations of a task. The use of a multimodal LLM encoder allows for training the multimodal LLM encoder for an LLM decoder with frozen parameters trained for an LLM encoder expecting an input of a single modality.

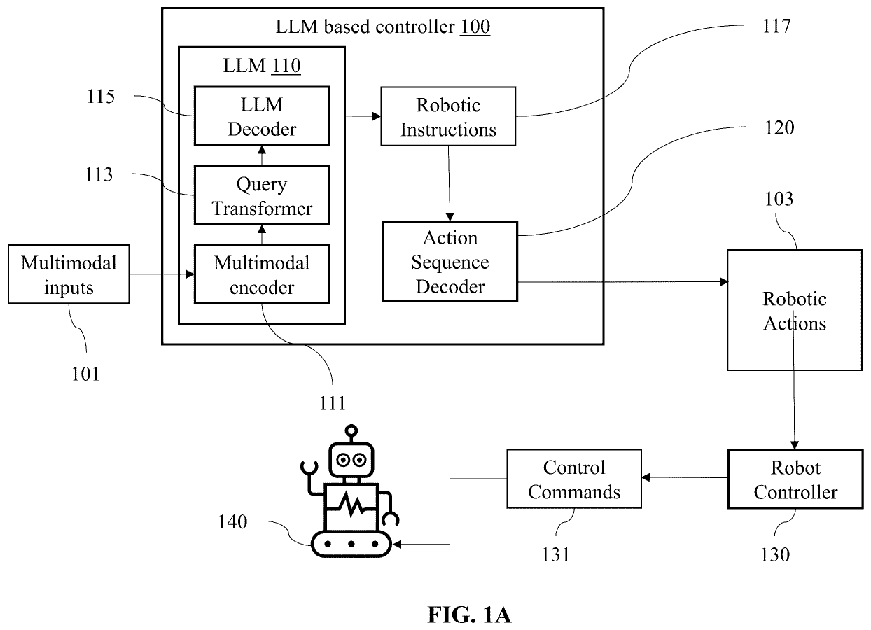

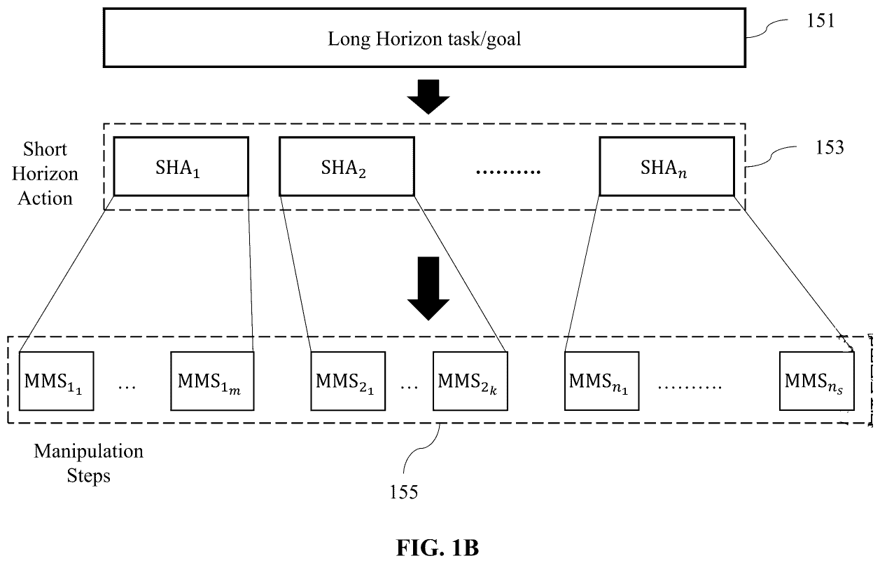

FIG. 1A illustrates a block diagram of a robotic controller 100 for controlling a robot 140 according to a sequence of actions 103 predicted using multimodal inputs 101, according to some example embodiments. The robotic controller 100 utilizes a large language model 110 and may be embodied as and also referred to as an LLM based controller 100. According to some embodiments, some components of the robotic controller 100 may be optional. The robotic controller 100 takes multimodal inputs 101 specifying general human instructions for performing a long horizon task in different modalities including audio, video, and a text modality. In an example, the robotic controller 100 is configured to control the robot 140 based on a set of human instructions demonstrating a task. For example, the set of human instructions may be provided as a video recording. In an embodiment, the robotic controller 100 is configured to acquire the multimodal inputs 101 from a server or a database, such as database of a creator creating a video demonstrating the set of human instructions, an online platform hosting the video, etc.

Therefore, the instructions in different modalities may be extracted from a video demonstration of the task. The video conveys the general instructions in i.) image modality through the image frames of the video, ii.) audio modality through the audio description of the video and iii.) text modality through the speech transcription of the description provided as audio in the video or as video captions. According to some embodiments, the multimodal inputs 101 may further comprise data from other modalities such as tactile inputs from one or more tactile sensors.

FIG. 1B illustrates a paradigm of robot action planning for a long horizon task/goal 151, according to some example embodiments. According to some embodiments, robot actions may be designed in a cascaded manner. For example, a long horizon goal 151 (for example: cook sandwich) may be broken down into a plurality of short horizon acts (SHA) 153 (such as grill tomato, cook bacon, place tomato and bacon on top of bread). Furthermore, each of the short horizon acts 153 may be broken down to one or more micro-manipulation steps (MMS) 155 (such as pick, place, cut), which can be executed by the robot 140 of FIG. 1A.

Referring back to FIG. 1A, the robotic controller 100 comprises a suitable interface to collect and receive the multimodal inputs 101. The robotic controller 100 also comprises a large language model (LLM) 110. The LLM 110 comprises a multimodal encoder 111, a query transformer 113 also referred to as Q-former, and an LLM decoder 115. The multimodal encoder 111 encodes the general instructions in each of the different modalities into a respective encoding of each of the instructions. For example, the multimodal encoder 111 may comprise an encoder for each of the modalities. The multimodal encoder 111 may jointly embed the multimodal inputs into the hidden representations of the same dimensionality as that of the hidden representation of an LLM encoder. Such a replacement of LLM encoder with the multimodal encoder 111 allows for training the multimodal LLM encoder for the LLM decoder with frozen parameters trained for the LLM encoder expecting an input of a single modality.

Additionally or alternatively, some embodiments employ a query-transformer (Q-Former) 113 that translates the multimodal encodings from the encoder 111 into “text-like” representations that can be ingested by a backend LLM decoder 115 thereby conditioning the LLM decoder 115 to produce its output in the form of the robotic instructions 117. According to some embodiments, the Q-Former 113 is multimodal. Some example embodiments leverage the LLM capabilities in the decoder 115 within the action sequence generation framework such that the extensive knowledge and inferential capabilities inherent in LLMs can be used to refine the generated action sequences. Such an integration allows incorporation of advanced LLMs for robotic manipulation.

The LLM decoder 115 decodes the text like representations of the encodings into a sequence of robotic instructions 117. According to some embodiments, the LLM decoder 115 may optionally comprise or be coupled to an action sequence decoder 120. LLM refers to a class of powerful artificial intelligence models that are capable of understanding and generating human language. These models are typically based on deep learning architectures, such as transformers, and are trained on large datasets to learn the statistical patterns and structures of language. In the LLM, the encoder and decoder are essential components used for various natural language processing tasks. Specifically, the LLM encoder processes the input text and transforms it into a series of hidden representations that capture the contextual information of the input. However, the LLM 110 illustrated in FIG. 1A uses the multimodal encoder 111 instead of an LLM encoder and provides hidden representations of each input modality. The LLM decoder 115 takes the hidden representations generated by the multimodal encoder 111 and uses them to generate an output sequence. According to some embodiments, the multimodal encoder 111 as well as the LLM decoder 115 may have transformer-based architectures that include multiple layers of self-attention and feedforward neural networks. However, in addition to self-attention, the LLM decoder 115 can also incorporate cross-attention, allowing it to attend to the encoder's output when generating the output sequence. This enables the LLM decoder 115 to generate output tokens based on both the input text and the context provided by the encoder.

The action sequence decoder 120 is trained with machine learning to transform the sequence of robotic instructions 117 into a sequence of actions 103 using a library of robotic skills. According to some embodiments, the library of robotic skills may be predetermined and stored in a memory. Alternately, in some embodiments, the library of robotic skills may be dynamically provided by another machine learning based system. According to another embodiment, the robotic controller may be configured without the action sequence decoder 120, wherein the LLM decoder is configured to directly decode the encodings into a sequence of actions.

The action sequence 103 has a semantic meaning similar to a semantic meaning of the robotic instructions 117 which in turn possess the semantic meaning of the human instructions demonstrated in the multimodal inputs 101. The generated action sequence 103 ensures semantic alignment with provided video human instructions 142. The semantic alignment provides the advantage of shared common knowledge to the robot 140, which is inherent in humans and helps in accurate and faster interpretation of similar human instructions. Some embodiments are based on the realization that semantic alignment helps to bridge a gap between human communication and robotic execution by retaining a semantic intent, embedded in the human instructions, in the generated action sequence 103.

According to some embodiments, the robotic instructions 117 specify short horizon tasks for the robot 140 which cannot be directly submitted to the robots. For example, if the robot 140 is a single arm robot, it cannot execute an exemplary short horizon task “Cut the apple and the tomato placed on the table” in one go. The short horizon task has to be broken down into micro manipulation steps and an action sequence can thereby be formulated. In this regard, the micro manipulation steps need to be connected with each other in a manner that ensures semantic meaning of the human instructions in the video and the formulated action sequence remain synchronized and matched.

From the exemplary short horizon task “Cut the apple and the tomato placed on the table”, the action sequence decoder 120 extracts contextual cues. For example, the action sequence decoder 120 discerns that a cut operation requires picking and/or placing the target in a suitable position, picking a cutting instrument, aligning the cutting instrument with the target in the suitable position and so on. This in turn requires knowledge of the target(s) and current position and/or orientation of the target(s). Thus, the action sequence decoder 120 formulates a sequence of robotic actions for each target separately unless they can be jointly processed. For example, for the exemplar short horizon task mentioned above, the action sequence may start from capturing the current position and/or orientation of the target, and proceed to picking and/or placing them in a desired position and orientation, picking a cutting instrument, aligning the instrument with the target's position and/or orientation, and operating the cutting instrument in a calculated manner.

According to some embodiments, the action sequence decoder 120 may be applied for implementation to generate the action sequence 103 corresponding to the set of robotic instructions 117. In particular, the action sequence 103 may include robot motor skills which can be represented either as state-based polices or goal-centric movement primitives such as dynamic movement primitives (DMPs) for the robot 140 such that performing the action sequence causes the robot 140 to perform the operation that is being demonstrated by the set of human instructions specified by the multimodal inputs 101.

In an example, the DMPs may be basic, pre-defined movement patterns or behaviors that can be combined to create more complex movements for robotic systems. For example, the DMPs could serve as building blocks for goal parameterized movement primitives allowing robots to perform a wide range of tasks by composing and sequencing these basic movement primitives. In an example, each action of the action sequence 103 may further include one or more DMPs (or skills) that simplifies control, planning and execution of the action by the robot 140. For example, a movement primitive associated with an action to be performed by the robot 140 may represent simple and well-defined movement that the robot 140 can execute. To this end, to accomplish the operation demonstrated through the human instructions in the multimodal inputs, the robot 140 may have to combine multiple DMPs. By sequencing and combining the basic DMPs of the action sequence 103, the robot 140 may be able to perform intricate movements to carry out the operation. For example, for an operation relating to assembling a puzzle, DMPs of the action sequence may relate to, for example, picking up pieces, rotating them, and placing them, where these DMPs are parameterized over puzzle type, etc. Moreover, the DMPs may also be used to generate trajectories that specify the robot's path through space and time. For example, trajectories may define how the robot 140 should move its joints or end effector to achieve a desired motion or perform an action from the action sequence 103. To this end, a combination of multiple DMPs may create a trajectory that represents the entire operation performed by the robot 140.

In an example, the basic movements defined by the DMPs can include, but is not limited to, movement towards right, movement towards left, moving upwards, moving downwards, any other form of reaching movement, grasping, lifting, rotating, or any other basic motion relevant to the robot's action. For example, the movement primitive may be parameterized using the goal and initial state of the robot, such that the movement primitive can be adjusted and scaled to adapt to different situations, objects, or tasks. For example, a reaching movement primitive may have parameters for target position, orientation, and speed. To this end, the action sequence decoder 120 is configured to produce the action sequence 103 such that action sequence 103 has a semantic meaning similar to a semantic meaning of the human instructions, i.e., semantically related to the general instructions specified by the multimodal inputs. Further, one or more actions in the action sequence 103 can be broken down into one or more DMPs that may ensure robotic execution of corresponding action to carry out the operation demonstrated in the human instructions reliably.

In an example embodiment, the robotic controller 100 may be applied for generating the sequence of robotic actions or the action sequence 103. For example, at first, some components of the LLM 110 and/or the action sequence decoder 120 may be applied for training, such as on one or more video recordings. During the training, some components of the LLM 110 and/or the action sequence decoder 120 may be applied to generate a sequence of actions from the recording. Further, once trained, the LLM 110 and/or the action sequence decoder 120 may be applied for implementation, such as on a video recording. During the implementation, the LLM 110 and/or the action sequence decoder 120 may be applied to generate an action sequence from the video recording.

The robotic actions 103 may be expressed in terms of robotic skills associated with the robot 140. For example, each operation demonstrated in the multimodal input 101 may be subdivided or broken into sub-operations that are expressed in terms of the robot skills. The robotic actions 103 thus generated are output to a robot controller 130 that generates control commands 131 in response to the skills described in each of the robotic actions 103. The control commands 131 specify values of currents and voltages and time durations of supply of current/power to one or more actuators of the robot 140. Thus, the robot 140 is controlled according to the sequence of actions predicted in accordance with the instructions specified in the multimodal demonstration input 101.

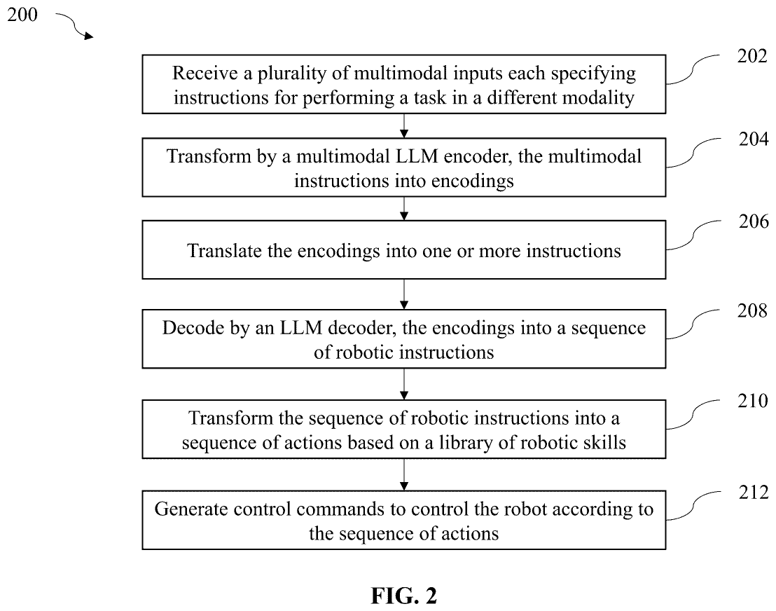

FIG. 2 illustrates a method 200 executed by the robotic controller 100 of FIG. 1A for controlling the robot 140, according to some example embodiments. The method comprises receiving 202 a plurality of multimodal inputs each specifying instructions for performing a task in a different modality. The multimodal instructions, provided as the multimodal inputs 101, are transformed 204 by the multimodal LLM encoder 111 into encodings of the inputs. The Q-former 113 translates 206 the encodings into one or more instructions conditioning the LLM decoder 115 to produce its output structured in a format compatible with the action sequence decoder 120.

The LLM decoder 115 decodes 208 the translated encodings into a sequence of robotic instructions 117. According to some embodiments, the Q-former 113 may be optional to the controller 100 and the step 206 may be skipped in the method 200. In such scenarios, the LLM decoder 115 may receive the encodings in a sufficiently comprehendible format and decode the encodings to produce the sequence of robotic instructions 117. According to some embodiments, the LLM decoder 115 may be configured to directly decode the encodings into a sequence of actions 103.

The action sequence decoder 120 transforms 210 the produced sequence of robotic instructions 117 into a sequence of robotic actions 103 using a library of skills in the manner as described with respect to FIG. 1A. A trajectory or robot controller 130 of the robot 140 generates 212 control commands 131 to control the robot 140 according to the sequence of actions 103.

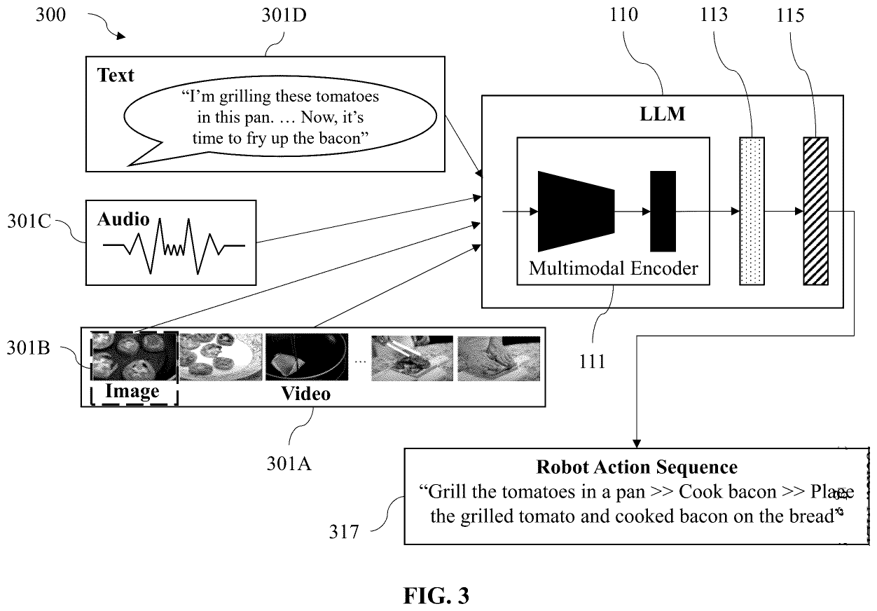

FIG. 3 illustrates schematics of an action sequence generation framework 300 of the robotic controller 100 of FIG. 1A, according to some example embodiments. In the example scenario shown in FIG. 3, the framework 300 is directed towards generating a sequence of actions for a single-arm robot from a human demonstration video. The multimodal encoder 111 concurrently processes video 301A, image 301B, audio 301C, and speech transcription 301D features. Such an encoder, allows effective leveraging of additional contextual information such as human speech and environmental sounds from the audio input 301C, thereby enhancing the overall performance of the generated tasks. The encoder's capability to process a diverse array of inputs, including video, speech, and text, facilitates a comprehensive understanding of the task at hand by assimilating both the visual demonstrations and auditory instructions from the environment. Moreover, the use of LLM in the decoder 115 in the action sequence generation task makes it possible to refine the generated actions using the inference capability of the LLM.

The deployment of the query-transformer (Q-Former) allows translation of the multimodal sensory input into “text-like” representations that can be ingested by the backend LLM decoder 115. The LLM decoder 115, conditioned on these “text-like” representations, generates actionable sequences 317 for robot manipulation.

Referring to FIG. 3, a video demonstration of a task “cook sandwich” performed by a human is given to the LLM 110 to generate a sequence 317 “grill tomato, cook bacon, place tomato and bacon on top of bread”. The output sequence 317 must be in the order in which a robot arm can execute them. For instance, when the robot has only one arm, it cannot pick tomatoes and a piece of bacon to put on the bread at the same time. Therefore, in that case, it is preferable to repeat the process of grasping and placing one by one. Thus, the LLM 110 predicts subtasks in the form of action sequences 317 based on their feasibility at execution.

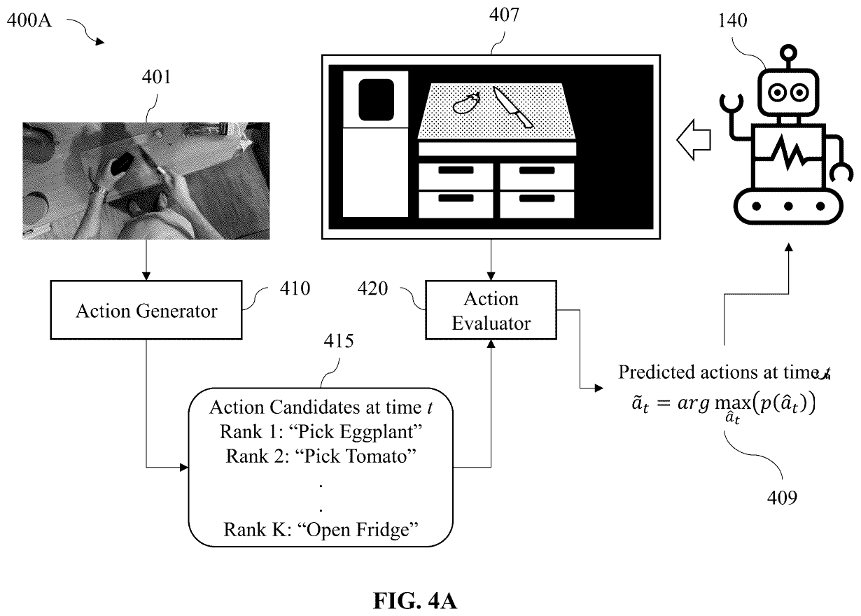

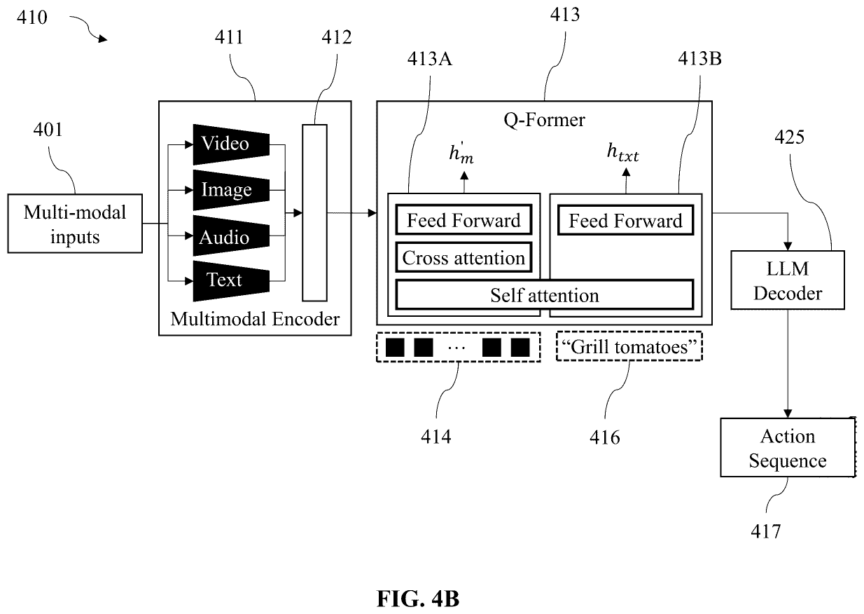

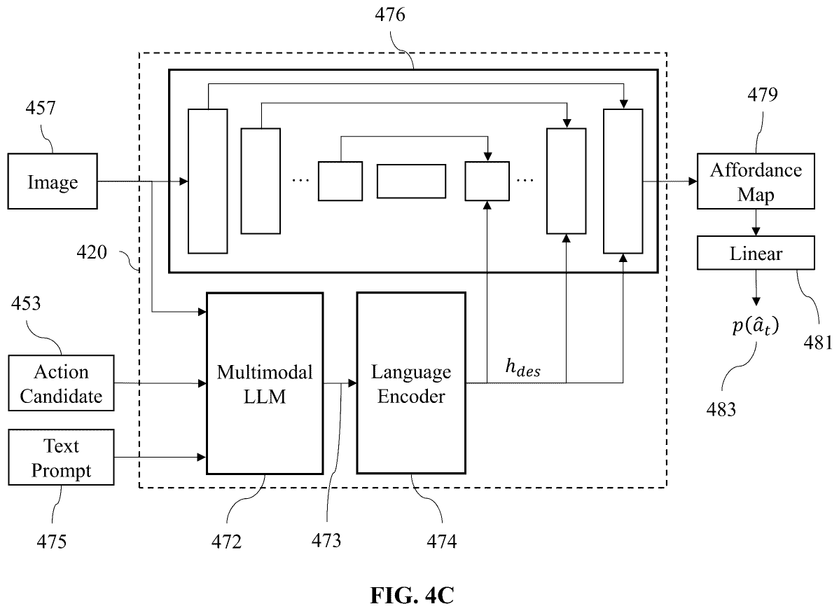

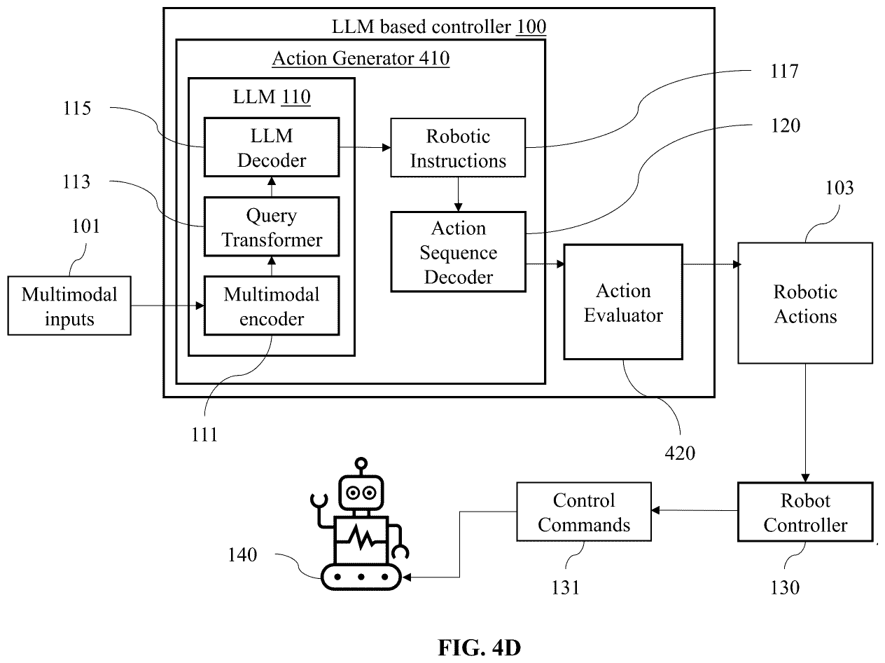

Towards this end, some embodiments design the framework 300 as a closed loop cascade of two modules: an action generator and an action evaluator to ensure that the action sequences 317 meet feasibility standards. FIG. 4A illustrates an overview of an action sequence generation framework 400A comprising an action generator 410 and an action evaluator 420, according to some example embodiments. The framework 400A allows a manipulator such as the robot 140 to perform tasks by interacting with the environment based on human demonstration videos such as the video 401. The Action Generator module 410 generates action candidates from the demonstration video 401. In this regard, the Action Generator 410 may be embodied structurally and functionally as the LLM based controller 100 of FIG. 1A. Each of the robotic actions of the robotic action sequence 103 generated by the controller 100 may have one or more action candidates 415 for the Action Evaluator 420. Alternately, the LLM decoder 115 of the controller 100 may provide action candidates for each time instance. The Action Generator 410 outputs a set of action candidates 415 at time t, denoted as

$$\{ {\hat{a}}_{t}^{( i )} \vert i = 1 , … , I \} ,$$

where I represents the number of action candidates produced by the Action Generator 410.

The Action Evaluator module 420 predicts the next action based on action candidates 415 generated by the Action Generator 410 and observations 407 of the robot 140 and the environment of the robot 140. According to some embodiments, the observations 407 may be collected by the robot 140. According to some embodiments, alternately or additionally, the observations 407 may be obtained using one or more sensors providing measurements in one or more sensor modalities for example, but not limited to, cameras, tactile sensing, lidar, encoders, radars. The Action Evaluator 420 predicts both an affordance map and the most probable action from the candidates 415. The structure and operation of each of these modules: Action Generator 410 and Action Evaluator 420 is described next.

FIG. 4B illustrates the network architecture of the Action Generator 410 of the action sequence generation framework of FIG. 4A, according to some embodiments. The Action Generator 410 comprises a Multimodal Encoder 411, a Q-former 413, and an LLM Decoder 425. The input to the network is a human demonstration video V={vi|i=1, . . . , T}, an audio waveform A, and a speech transcription S. Here, vₜ represents an image at time t.

The training procedure of the Action Generator 410 comprises two stages: (1) vision language representation learning with frozen multimodal encoders and (2) vision-to-language generative learning with a frozen LLM. Each of these is described in detail below:

Vision-language representation learning: In the first stage, the objective is to align the multimodal feature hₘ with the text features obtained from the action sequences, in the Q-former 413.

In the Q-former 413, the multimodal transformer 413A computes cross-attention between the learnable tokens 414 {zⱼ|j=1, . . . , N} and hₘ, and the multimodal feature extracted by the multimodal encoder 411. Finally, the multimodal transformer 413A outputs

$${h}_{m}^{′} ∈ {ℝ}^{N \times d} ,$$

where N and d denote the number of learnable tokens 414 and the dimension of the tokens 414, respectively. On the other hand, a text transformer 413B computes self-attention of an input action sequence T 416. The transformer 413B outputs the first token of the feature as the text feature hₜₓₜ.

According to some embodiments, in the first stage of training, three types of pre-training objectives may be employed to align the multimodal features of audio, video, and speech with the language features: Video-Text Contrastive Learning (VTC), Video-grounded Text Generation (VTG), and Video-Text Matching (VTM). The objective function of VTC is given as:

$${ℒ}_{vtc} = \frac{1}{2} ( {ℒ}_{CE} ( {s}_{m 2 t} , {s}_{ref} ) + {ℒ}_{CE} ( {s}_{t 2 m} , {s}_{ref} ) ) , \\ where {s}_{m 2 t} = \frac{max ( {h}_{m}^{′} \cdot {h}_{txt}^{T} )}{τ} , {s}_{t 2 m} = \frac{max ( {h}_{txt} \cdot {h}_{m}^{′ T} )}{τ} .$$

Furthermore, the s_{ref} denotes the reference labels, specifically the index of the correct pair of action sequences and demonstration videos. VTC maximizes mutual information between multimodal features and text features by using contrastive learning. This involves maximizing the multimodal text feature similarity of positive pairs.

Next, VTG learns to minimize the prediction error of each token when generating action sequences using multimodal features. The objective function of this is as follows:

$${ℒ}_{vtg} = {ℒ}_{CE} ( T , {f}_{c} ( {h}_{txt} ) ) ,$$

where [symbol] _{CE} (⋅) and f_{c} (⋅) represent the cross-entropy loss function and a linear layer, respectively, and Tis the ground truth action sequence from a dataset.

Finally, VTM aims to acquire more detailed alignment capabilities than VTC by addressing a binary classification task, predicting which action sequence as a whole is paired with which demonstration video. The objective function of VTM is as follows:

$${ℒ}_{vtm} = {ℒ}_{BCE} ( {h}_{m}^{′} ) ,$$

where [symbol] _{BCE} (⋅) denotes the binary cross entropy loss function. The loss

function at this stage can be written as follows from the above:

$$ℒ = {ℒ}_{vtc} + {ℒ}_{vtg} + {ℒ}_{vtm}$$

Vision-to-language generative learning: In the second stage, the Q-former 413 is connected to the LLM Decoder 425 and multimodal action sequence generation is performed. In this stage, the parameters of the layers of the Q-former 413 are updated. As shown in FIG. 4B, the output

$${h}_{m}^{′}$$

obtained by the Q-former 413 is processed by using a linear layer. Note that the text transformer 413B is not used in this stage. Then, the LLM Decoder 425 generates action sequences 417 from the features. The cross-entropy loss function is used as a loss function in this stage.

### Model Architecture

Multimodal Encoder 411: From the network input 101, the multimodal encoder 411 extracts four types of features: video, image, audio, and speech (text). An input to this module may be a human demonstration video. The output of this module is the intermediate feature hₘ.

Q-former 413: This module learns to align hₘ with text features obtained from action sequences. The inputs to this module are {zⱼ|j=1, . . . , N} and hₘ. In the first stage training, described above, T is also input. This module extracts a latent vector

$${h}_{m}^{′} .$$

AS shown in FIG. 4B, the Q-former 413 has two transformer submodules that share the same self-attention layers: (1) a multimodal transformer 413A and (2) a text transformer 413B that works as a text encoder and a text decoder. According to some embodiments, the Q-former is trained to bridge the gap between the multiple modalities in the input 101 and text modality accepted by the LLM decoder 425.

LLM Decoder 425: This module predicts an action sequence y from the text feature

$${h}_{m}^{′}$$

obtained by the Q-former. The LLM Decoder 425 is constructed with a frozen LLM and a learnable feed-forward layer. Using the LLM as a decoder leverages the LLM's inference capabilities when generating action sequences.

FIG. 4C illustrates the network architecture of the Action Evaluator 420, according to some embodiments. The inputs to the Action Evaluator 420 include the observations (x_{obs}) of the robot and/or the environment of the robot captured as one or more images 457, the action candidates

$$( {\hat{a}}_{t}^{( i )} )$$

453, and optionally a text prompt (T) 475 associated with the observations and the action candidates. For example, the observation may be processed and additional prompt with respect to one or more objects in the image 457 may be fetched from the LLM or a user. In this regard some embodiments may utilize an encoder to extract features from the image 457 and obtain a detailed description of the image while considering the action candidate. According to some embodiments the images 453 may be RGB images captured by the manipulator or information captured in any suitable modality. The action evaluator 420 outputs the action

$${\tilde{a}}_{t}^{( i )}$$

predicted to be most feasible. For readability, hereinafter, unless otherwise stated,

$${\hat{a}}_{t}^{( i )}$$

will be denoted as âₜ.

In the Action Evaluator 420, x_{obs}, âₜ, and T are input into a multimodal LLM 472 to obtain a description 473 including the feasibility of âₜ. Subsequently, the description 473 is encoded using a Language Encoder 474 to acquire linguistic features h_{des}. These linguistic features are then concatenated with image features in a semantic agent 476 to acquire multimodal features.

The semantic agent module first uses N layers of convolutional neural network (CNN) to extract intermediate features

$${h}_{obs}^{( n )} h ( n )$$

obs from each layer. Following this, feature up sampling is performed based on the following equation:

$${h}_{obs}^{′ ( n + 1 )} = {f}_{up} ( [ {h}_{obs}^{′ ( n )} ; {h}_{\backslash des} ] ) .$$

The semantic agent module 476 outputs

$${h}_{obs}^{′ ( N )}$$

which is an alignment feature for the observations 457 and the descriptions 475 related to the predictability of candidate actions by LLM. Therefore, it can be considered as an affordance map 479 regarding the feasibility of actions 453. Based on the affordance map, a linear function 481 outputs the predicted probability 483 of the feasibility of âₜ. The predicted probability 483 is denoted as p(âₜ). This computation is repeated/times, eventually outputting the action âₜ predicted to have the highest probability 483 of feasibility.

In this manner, the action evaluator 420 may be integrated as a validation layer that determines which action of a set of actions is the best candidate to be output in the robot action sequence output by the action sequence decoder 120. In such embodiments, the output of the action sequence decoder 120 is further evaluated and next actions can be validated using the action evaluator 420. According to some embodiments, the action âₜ predicted to have the highest probability 483 of feasibility may be used to refine the sequence of actions 415 generated by the action sequence generator 410.

FIG. 4D illustrates a block diagram of a LLM based controller 100 for controlling a robot 140 according to a sequence of robotic actions 103 predicted using multimodal inputs, based on the action sequence generation framework 400A, wherein the action sequence decoder 120 is configured to generate a plurality of action candidates, which is in the form of the action candidates 415 in FIG. 4A, according to some example embodiments. An action within the scope of this disclosure may be contemplated to encompass one of a verb or a verb with a subject noun. FIG. 4D illustrates several components that are already described with reference to FIG. 1A and therefore the description of those components is not repeated herein for the sake of brevity. The LLM decoder 115 or the action sequence decoder 120 may use a beam search technique to generate a plurality of action candidates. According to some embodiments, the robotic controller may be configured without the action sequence decoder, wherein the LLM decoder 115 is configured to directly decode the encoding into a plurality of action candidates, which is in the form of the action candidates 415 in FIG. 4A. The LLM decoder 115 may use a beam search technique to generate a plurality of action candidates.

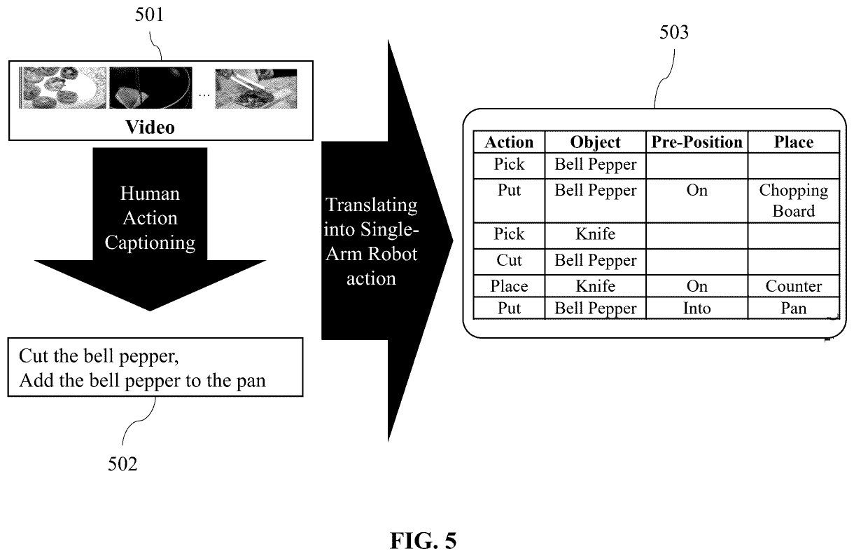

FIG. 5 illustrates schematics of data collection for micro action step generation for a single arm robot, according to some embodiments. To generate an action sequence that a single-arm robot could perform, human action steps can be translated into micro action steps. In this regard, human workers can generate single-arm robot actions by selecting “single-arm action”, “target object”, “preposition”, and “place” to achieve the same actions by humans. As an example, one-hand actions may be selected from a pool of candidate actions such as: Open, Close, Pick, Place, Pour, Stir, TurnOn, TurnOff, Wipe, Cut, Scoop, Squeeze. The target objects may be selected as one of the nouns in the human action captions as much as possible.

As illustrated in FIG. 5, the data collection comprises human action captioning of a given input such as a video 501 to obtain human action captions 502. These captions are translated into single-arm robot actions 503 defined in terms of robotic skills, target object, pre-position and placement of the target object. Although the data collection framework is described for a single arm robot, it may be contemplated that likewise the data collection may be performed multiple robots or for other types of robots as well.

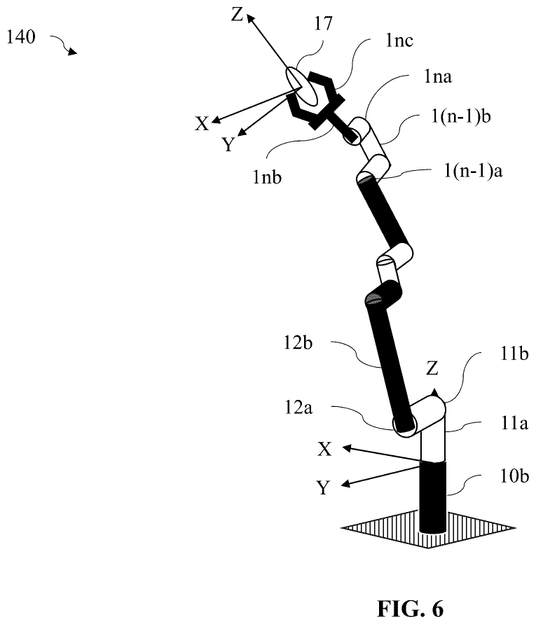

FIG. 6 illustrates schematics of the robot 140 for object manipulation, in accordance with some example embodiments. Hereinafter, the robot 140 may also be referred to as a manipulator 140. The manipulator 140 may be an n degree-of-freedom (DOF) open-chain manipulator. The manipulator 140 comprises a base 10b, multiple joints, multiple links and an end-effector 10nc where each joint may typically move in one or more directions. The manipulator 140 may be used to perform one or more tasks such as manipulating one or more payloads such as an object 17. The specific task may be defined in terms of parameters including, e.g., an initial position and velocity of the object 17, a final position and velocity of the object 17, acceleration and velocity constraints on the object 17, time to accomplish the task, and the like. The manipulator 101 may be electronically coupled to a control system such as the robot controller 130 of FIG. 1A that provides control inputs/commands to execute the task. According to some embodiments, the base 10b may be mountable on a surface such as the floor or a movable platform. The other end of the base 10b may be mechanically coupled with a first-axis link 11b through a first-axis joint 11a. The first-axis link 11b is coupled with a second-axis joint 12a, which is connected to a second-axis link 12b. This coupling and connection patterns are repeated until reaching the end-effector Inc, which is attached on a last-axis link 1nb. The last-axis link 1nb is coupled with a previous link 1(n−1)b through a last-axis joint 1na. According to some embodiments, one or more components of the manipulator 140 may be modeled in any suitable manner such as in terms of mathematical equations and a corresponding model of the components may be accessible to the control system of the manipulator 103. Each such model may describe interaction between various variables pertaining to the corresponding component such as control input variables, state variables (for example position, orientation, heading etc.).

In some embodiments, a joint of the manipulator 140 may be of any suitable type including but not limited to: revolute, prismatic, helical etc. The movements of the joints of the manipulator 140 may be controlled by one or more actuators coupled to the joints such that the manipulator 140 can be moved in accordance with one or more control inputs to effectuate manipulation of the payload 17 along any dimension.

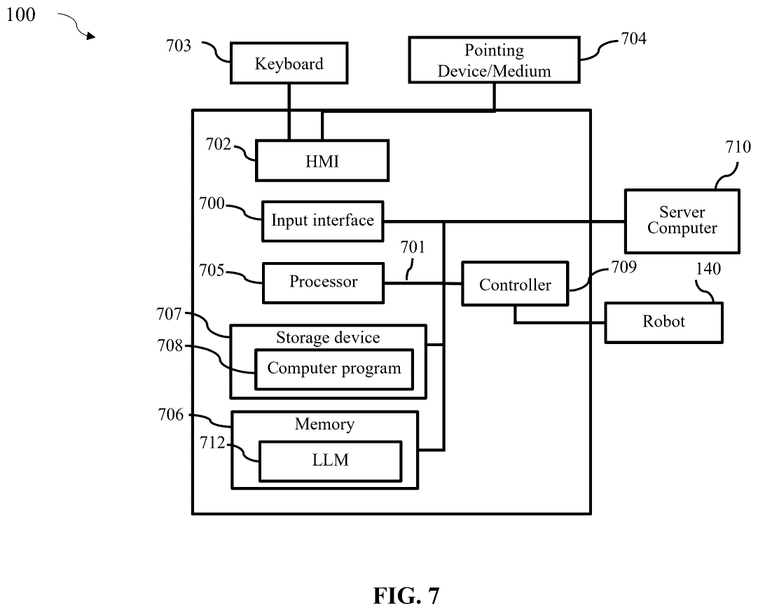

FIG. 7 shows a block diagram of the robotic controller 100 of FIG. 1A for controlling the robot 140, according to some embodiments of the disclosure. The controller 100 includes an input interface 700 configured to receive input data indicative of the task to be performed by the robot 140. The input data may be used to control the robot 140 from a start pose to a goal pose to perform the task. In this regard, the input interface 700 may be configured to accept a recording for performing the task. The recording may include various operations to be performed by the robot 140 in order to execute or carry out the task, and an output for the robot 140 that may be indicative of completion of the task. In some embodiments, the input interface 700 is configured to receive input data indicative of video and audio signals along with text transcriptions, i.e., a sequence of caption indicative of human demonstration of the task. For example, the input data corresponds to multi-modal information, such as audio, video, textual, natural language, or the like. In certain case, the input data may include sensor-based video information received or sensed by visual sensors, sensor-based audio information received or sensed by audio sensors and, or a natural language instruction received or sensed by language sensors. The input data may be raw measurements received from the sensors or any derivative of the measurements, representing the audio, video and/or textual information and signals corresponding to the recording.

In one embodiment, the robot 140 is a set of components, such as arms, feet, and end-tool, linked by joints. In an example, the joints may be revolutionary joints, sliding joints, or other types of joints. The collection of joints determines degrees of freedom for the corresponding component. In an example, the arms may have five to six joints allowing for five to six degrees of freedom. In an example, the end-tool may be a parallel-jaw gripper. For example, the parallel-jaw gripper has two parallel fingers whose distance can be adjusted relative to one another. Many other end-tools may be used instead, for example, an end-tool having a welding tip. The joints may be adjusted to achieve desired configurations for the components. A desired configuration may relate to a desired position in Euclidean space, or desired values in joint space. The joints may also be commanded or controlled by a controller 709 of the robotic controller 100 in the temporal domain to achieve a desired (angular) velocity and/or an (angular) acceleration. The joints may have embedded sensors, which may report a corresponding state of the joint. The reported state may be, for example, a value of an angle, a value of current, a value of velocity, a value of torque, a value of acceleration, or any combination thereof. The reported collection of joint states is referred to as the state. In some embodiments, the robot 140 may include a motor or a plurality of motors configured to move the joints to change the motion of the arms, the end-tool and/or the feet according to a command produced by the controller 709.

The controller 100 may have a number of interfaces connecting the controller 100 with other systems and devices. For example, the controller 100 is connected, through a bus 701, to a server computer 710 to acquire the recordings via the input interface 700. Additionally, or alternatively, in some implementations, the controller 100 includes a human machine interface (HMI) 702 that connects a processor 705 to a keyboard 703 and a pointing device 704, wherein the pointing device 704 may include a mouse, trackball, touchpad, joystick, pointing stick, stylus, or touchscreen, among others. Additionally, the controller 100 may be connected to a trajectory controller 709. The controller 709 is configured to operate the motor(s) of the robot 140 to change the placement of the arms, the end-tool and/or the feet according to a sequence of actions for the robot 140. For example, the sequence of actions for the robot 140 is received by the controller 709 via the bus 701, from the processor 705. In an example, the bus 701 is a dedicated data cable. In another example, the bus 701 is an Ethernet cable. For example, the robot 140 may be commanded or controlled by the controller 709 to perform, for example, a cooking task, based on a recording received by the processor 705 via the input interface 700 and the sequence of actions 136 determined by the processor 705 by applying the LLM 712. For example, the sequence of actions to perform the cooking task may form part of a set of task descriptions or commands sent to the robot 140.

It may be noted that references to a robot, without the classifications “physical”, “real”, or “real-world”, may mean a physical entity or a physical robot, or a robot simulator which aims to faithfully simulate the behavior of the physical robot. A robot simulator is a program consisting of a collection of algorithms based on mathematical formulas to simulate a real-world robot's kinematics and dynamics. In an embodiment, the robot simulator also simulates the controller 709. The robot simulator may generate data for 2D or 3D visualization of the robot 140.

The robotic controller 100 includes the processor 705 configured to execute stored instructions, as well as a memory 706 that stores instructions that are executable by the processor 705.

The controller 100 may also include a storage device 707 adapted to store different modules storing executable instructions for the processor 705. The storage device 707 may also store a computer program 708 for producing training data indicative of recording, testing recordings, validation recordings, action sequences and/or action labels relating to tasks that the robot 140 may have to perform. The storage device 707 may be implemented using a hard drive, an optical drive, a thumb drive, an array of drives, or any combinations thereof. The processor 705 is configured to determine a control law for controlling the motor(s) of the robot 140 based on the sequence of skills to move the arms, the end-tool, and/or the feet according to the controls and execute the self-exploration program 708 that performs the task demonstrated in the recordings 132.

The controller 100 may be configured to control or command the robot 140 to perform a task, such as a cooking task from an initial state of the robot 140 to a target or end state of the robot 140 by following a sequence of actions produced by the LLM 712. The sequence of actions may include or may be broken down into various short-horizon steps or action labels, which may be considered as abstract representations for robot actions or dynamic movement primitives (DMPs) for the robot 140.

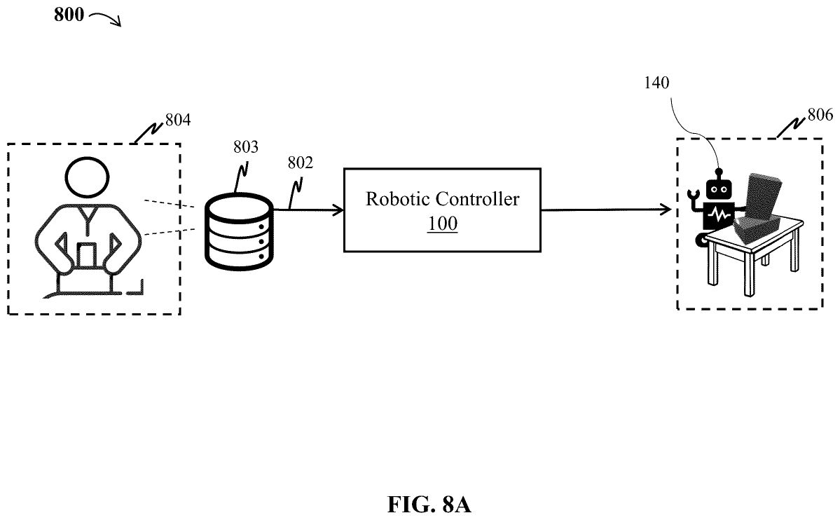

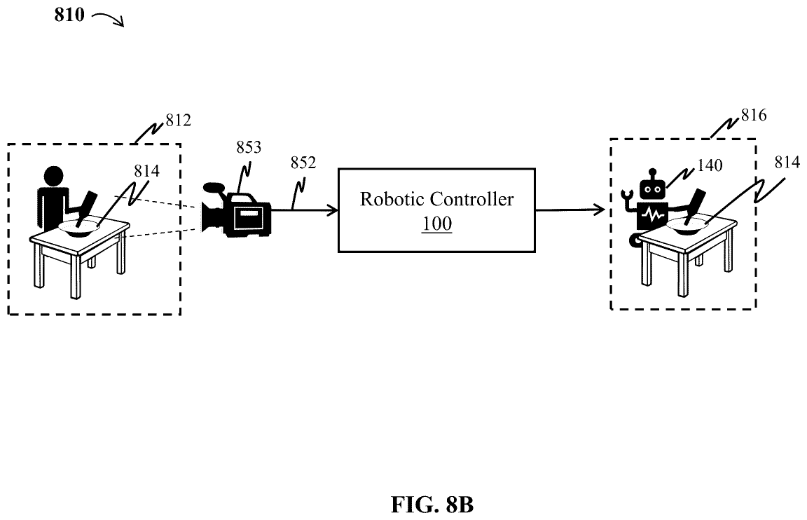

FIG. 8A and FIG. 8B illustrate schematic diagrams 800 and 810, respectively, of execution of an operation by the robot 140, in accordance with an embodiment of the present disclosure.

In an example, the robot 140 may be configured to perform the operation, such as assembling an entity (as shown in FIG. 8A) or make a bowl of cereal (as shown in FIG. 8B). In this regard, the controller 100 may acquire a video recording, such as the instructional video 802 comprising human demonstration on how to assemble the entity or make the bowl of cereal from multimodal data 802 provided by a suitable source such as a database 803 in FIG. 8A or a video camera 853 in FIG. 8B. In some embodiments, the controller 100 may acquire the multimodal data 803 as an instructional video 852 from a database or a server computer. For example, based on the instructional video 852, a sequence of frames may be generated. As may be understood, the sequence of frames may be captured by the multimodal data 803 at a specific rate, and when played in sequence, may create the instructional video 852. Each frame carries various parameters and characteristics that influence the overall quality and appearance of the video.

In an example, the multimodal data 802 or the instructional video 852 may include captions. In certain cases, machine-learning based platforms may be used for generating the captions for the instructional video 852.

Further, the feature data of the video recording 852 may be encoded to produce encoded features. For example, the encoded features may include encoded video feature data, audio feature data and text feature data that may indicate the human demonstration of the operation for, for example, assembling the entity or making the bowl of cereal. Further, the robotic controller 100 is applied for implementation to decompose the encoded features into an action sequence. In an example, each action is represented as a dynamic movement primitive (DMP). Further, the action sequence decoder 120 of the robotic controller 100 may be configured to produce the action sequence or the sequence of dynamic movement primitives for each sub-task demonstrated in the video recording 852. Each sub-task is completed by executing one or more DMPs.

In an example, the robot 140 may utilize sensors, such as RGB camera, voltage sensor, current sensor, etc. while carrying out the action sequence or the sequence of DMPs. The sensors may be used to detect the pose of objects, such as milk carton, bowl, cereal carton, components of the entity, tools, or machines, etc. during the execution of the operation.

For example, 804 and 812 show a human demonstration of assembling the entity and making a bowl of cereal, respectively. To this end, such human demonstration may be a part of one or more digital frames. For example, based on the human demonstration, feature data may be extracted from the digital frames. For example, audio, video, and textual feature data may be encoded to understand interaction and relationships between the objects and the human, as well as other properties of the interactions and relationships. Based on the encoded features, an action sequence of DMPs may be produced that could be implemented by the robot 140. For example, DMPs may be aligned to predefined set of actions, such as short-horizon action labels, which may include a predefined number of verbs or actions and a predefined number of nouns or objects. Based on the DMPs of the predefined set of actions, the action sequence for implementing the operation of “assemble the entity” or “make a bowl of cereal” may be implemented. In this regard, a suitable controller such as the trajectory/robot controller 130 may convert the actions into control commands for the actuators of the robot. The controller 130 may be a part of the robotic controller 100 or the robot 140 or separately located from both.

Referring to FIG. 8A, at 804, the human demonstration of assembling the entity may include demonstration of action steps for assembling components of the entity using machines, tools etc. In an example, a human demonstrating the operation of assembling the entity may have an audio description “insert component A into a cavity in the component B and fasten it using a screw”. For example, based on the human demonstration of the operation, the produced action sequence may include actions, but is not limited to, ‘move XYZ distance to right’, ‘lower arm, ‘open gripper’, ‘pick component A’, ‘raise arm’, ‘move to ABC position’, ‘insert component A into cavity of component B’, ‘release component A’, ‘move to DEF position’, ‘lower arm’, ‘pick a fastener’, ‘raise arm’, move to ABC position’, insert fastener to form joint’, etc.

As shown in 806, the robot 140 is controlled to perform DMPs to execute the operation of “assemble the entity”. For example, each of the DMPs of the action sequence may be performed by the robot 140 by controlling actuators of the robot 140 using control commands corresponding to the action sequence or the DMPs.

Referring to FIG. 8B, at 812, the human demonstration of making a bowl of cereal may include demonstration of an action of pouring milk into a bowl 814. In an example, a human demonstrating the operation of making the bowl of cereal may have an audio description “add cereal to the bowl and add milk to the bowl”. For example, based on the human demonstration of the operation, the produced action sequence may include actions, but is not limited to, “pick a bowl”, “place the bowl on a table in upright position”, “hold a cereal carton”, “tilt the cereal carton”, “move the cereal carton back and forth” “add cereal to the bowl until the bowl is one-third full”, “put down the cereal carton on the table”, “pick up a milk carton”, “tilt the milk carton over the bowl”, “pour milk from the milk carton in the bowl”, “put down the milk carton on the table”, “pick out a spoon”, and “stir the cereal and milk in the bowl”.

As shown in 816, the robot 140 is controlled to perform DMPs to execute the operation of “making a bowl of cereal”. For example, each of the DMPs of the action sequence may be performed by the robot 140 by controlling actuators of the robot 140 using control commands corresponding to the action sequence or the DMPs.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A robotic controller including circuitry, comprising:
an input interface configured to receive a plurality of multimodal inputs each specifying instructions in a different modality;
a multimodal large language model (LLM) including a multimodal LLM encoder and an LLM decoder, wherein the multimodal LLM encoder is trained with machine learning to transform the multimodal instructions into encodings and the LLM decoder is configured to decode the encodings into a sequence of actions; and
a trajectory controller configured to control a robot according to the sequence of actions.

2. The robotic controller of claim 1, wherein to decode the encodings into a sequence of actions, the LLM decoder is configured to decode the encodings into a sequence of robotic instructions and wherein the robotic controller further comprises an action sequence decoder trained with machine learning to transform the sequence of robotic instructions generated by the LLM decoder into a sequence of actions based on a library of robotic skills.

3. The robotic controller of claim 1, further comprising:
a query-transformer (Q-Former) trained with machine learning to translate the encodings of the multimodal LLM encoder into an instruction conditioning the LLM decoder to produce its output structured in a format compatible with the trajectory controller.

4. The robotic controller of claim 1, further comprising:
a memory configured to store an action evaluator module; and
one or more processors configured to execute the action evaluator module to:
collect a plurality of action candidates for each action in the sequence of actions generated by the action sequence decoder;
collect one or more first observations of an environment of the robot and one or more second observations of the robot;
collect a text prompt associated with at least one of the one or more first observations or the one or more second observations and the plurality of action candidates;
compute a probability of feasibility for each action candidate of the plurality of action candidates, based on the one or more first observations and the one or more second observations and the text prompt; and
select, an action candidate from among the plurality of action candidates whose probability of feasibility is maximum among the plurality of action candidates, as the most feasible action candidate.

5. The robotic controller of claim 4, wherein the one or more processors are further configured to generate a refined sequence of actions based on the most feasible action candidate corresponding to each action in the sequence of actions generated by the action sequence decoder.

6. The robotic controller of claim 5, wherein the trajectory controller is configured to generate control commands to control the robot in accordance with the refined sequence of actions.

7. The robotic controller of claim 3, wherein the Q-Former comprises a multimodal transformer trained with trainable tokens and a text transformer that shares the same self-attention layers with the multimodal transformer, and wherein the multimodal transformer is configured to compute cross-attention between the learnable tokens and the encodings of the multimodal LLM encoder and output a latent vector of the encodings of the multimodal LLM encoder.

8. The robotic controller of claim 1, wherein the sequence of actions corresponds to a sequence of dynamic movement primitives (DMPs) to be executed by the robot.

9. The robotic controller of claim 1, wherein the modalities of the instructions specified by the multimodal inputs include a video modality, an audio modality, and a text modality.

10. A computer-implemented method for applying a robotic controller including a multimodal large language model (LLM), an action sequence decoder trained with machine learning, and a trajectory controller for controlling a robot according to a sequence of actions, the method comprising:
receiving a plurality of multimodal inputs each specifying instructions in a different modality;
transforming the multimodal instructions into encodings using a multimodal LLM encoder of the multimodal LLM that is trained with machine learning;
decoding the encodings into a sequence of robotic instructions using an LLM decoder of the multimodal LLM;
transforming the sequence of robotic instructions into a sequence of actions based on a library of robotic skills, using the action sequence decoder; and
controlling the robot according to the sequence of actions using the trajectory controller.

11. The computer-implemented method of claim 10, further comprising:
applying a query-transformer (Q-Former) trained with machine learning to translate the encodings of the multimodal LLM encoder into an instruction conditioning the LLM decoder to produce its output structured in a format compatible with the action sequence decoder.

12. The computer-implemented method of claim 10,
wherein the multimodal LLM further comprises:
a memory configured to store an action evaluator module; and
one or more processors configured to execute the action evaluator module for:
collecting a plurality of action candidates for each action in the sequence of actions generated by the action sequence decoder;
collecting one or more observations of an environment of the robot and a text prompt associated with the observation and action candidates;
computing a probability of feasibility for each action candidate of the plurality of action candidates, based on the observations and the text prompt; and
selecting an action candidate whose probability of feasibility is maximum among the plurality of action candidates, as the most feasible action candidate.

13. The computer-implemented method of claim 12, further comprising generating a refined sequence of actions based on the most feasible action candidate corresponding to each action in the sequence of actions generated by the action sequence decoder.

14. The computer-implemented method of claim 13, further comprising generating control commands to control the robot in accordance with the refined sequence of actions.

15. The computer-implemented method of claim 10, wherein the modalities of the instructions specified by the multimodal inputs include a video modality, an audio modality, and a text modality.

16. A non-transitory computer-readable medium having stored thereon, computer-executable instructions that when executed by a computer system, causes the computer system to perform a method for applying a robotic controller including a multimodal large language model (LLM), an action sequence decoder trained with machine learning, and a trajectory controller for controlling a robot according to a sequence of actions, the method comprising:
receiving a plurality of multimodal inputs each specifying instructions in a different modality;
transforming the multimodal instructions into encodings using a multimodal LLM encoder of the multimodal LLM that is trained with machine learning;
decoding the encodings into a sequence of robotic instructions using an LLM decoder of the multimodal LLM;
transforming the sequence of robotic instructions into a sequence of actions based on a library of robotic skills, using the action sequence decoder; and
controlling the robot according to the sequence of actions using the trajectory controller.
